(19) United States
(12) Patent Application Publication
(10) Pub. No.: US 2008/0297929 A1
(43) Pub. Date: Dec. 4, 2008

(54) Door Mounting Plate with Built-in Rear-View Mirror Function

(75) Inventors: Bertrand Reyss, Orsay (FR); Jean-Jacques Rykaert, Villemomble (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., Boulogne Billancourt (FR)

(21) Appl. No.: 12/095,125

(22) PCT Filed: Nov. 14, 2006
(86) PCT No.: PCT/FR2006/051170

§ 371 Date: Jun. 27, 2008

(30) Foreign Application Priority Data
Nov. 29, 2005 (FR) 05-12066

(51) Int. Cl. B60R 1/07; G02B 7/182

(52) U.S. Cl. 359/877

(57) ABSTRACT

A device for a vehicle including a support, a control on the support, the control actuatable by a user to control movement of a rear-view mirror, and a selector on the support, the selector being actuatable by the user to select between: a first mode of controlling the rear-view mirror whereby the movement of the rear-view mirror is controlled by the control, or a second mode of controlling the rear-view mirror whereby the movement of the rear-view mirror is controlled by another mechanism not located on the support.

The present invention relates to a control device for a vehicle.

More specifically, the present invention relates to a device for controlling electrically powered accessories, in particular for a motor vehicle.

The increase in the number of electrically powered accessories on board motor vehicles is accompanied by an associated increase in the number of devices used to control them.

Motor vehicles today comprise, for example, one or more devices for controlling the movement of the mirrors of the exterior rear-view mirror units of the vehicle, one or more devices for controlling the movement of the electric exterior rear-view mirror units, one or more devices for controlling the movement of the electric windows of the vehicle, one or more devices for controlling the movement of the electric doors of the vehicle, etc.

This increase in the number of control devices represents a disadvantage in terms of space requirement.

Another disadvantage of this increase in the number of control devices concerns the increase in the length of electric cable used in such motor vehicles.

Yet another disadvantage concerns the increasing difficulties of mounting such control devices at the manufacturing stage of the motor vehicles.

One object of the invention is to provide an improved device for controlling electrically powered accessories in a vehicle.

Another object of the invention is to provide a control device by means of which at least one of the aforementioned disadvantages can be resolved.

Accordingly, the invention provides a control device comprising a support and control means on the support which can be actuated by a user to control the movement of a rear-view mirror unit, the device additionally comprising selection means on the support which can be actuated by the user to select a first control mode whereby the movement of the rear-view mirror unit is controlled by the control means, or a second control mode whereby the movement of the rear-view mirror unit is controlled by other means not located on the support.

Preferred, but non-limiting, aspects of the process according to the invention are as follows:
the device additionally comprises second control means which can be actuated by the user to control the movement of a window of the vehicle, the second control means being located on the support;
the device additionally comprises third control means which can be actuated by the user to control the movement of a mirror of the electric rear-view mirror unit, the third means being located on the support;
the support is formed in a single piece;
the support is designed to be fastened on a door of the vehicle;
the first control means and the first selection means are integrated within the same assembly;
the assembly comprises a rocker button with three positions;
the second control means comprise at least one button which can be actuated to control the movement of the window of the vehicle;
the device additionally comprises fourth control means which can be actuated by the user to control the movement of an electric door of the vehicle, the fourth means being located on the support;
the device additionally comprises fifth control means which can be actuated by the user to deactivate the second control means and/or the fourth control means.

For example, in one embodiment, the fifth control means make it possible to simultaneously deactivate the second and fourth control means. These fifth means comprise, for example, a two-position rocker button. The first position makes it possible to deactivate the second and fourth control means such that the rear doors of the vehicle and the rear electric windows of the vehicle can no longer be moved. The second position makes it possible to activate the second and fourth control means such that the rear doors and the rear windows of the vehicle can be moved.

For the purposes of the present invention, the term “movement” is intended to mean a relative movement of an accessory with respect to the vehicle body.

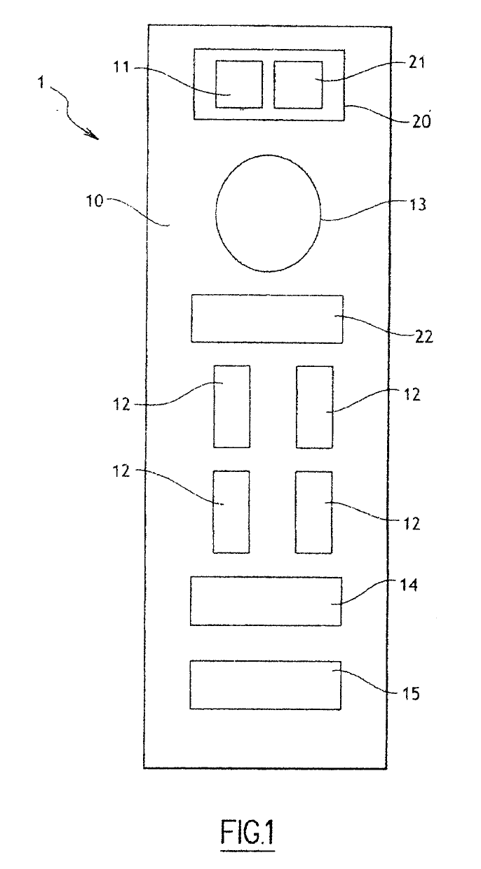

Other features and advantages will become apparent from the description which follows, which is purely illustrative and non-limiting and should be read with reference to FIG. 1, appended, which illustrates a functional diagram of the device according to the invention.

The present invention relates to a device designed to be mounted on a door of a vehicle.

This device makes it possible in particular to command electric motors of various accessories of the vehicle to move these accessories.

These accessories are, for example, front and/or rear windows, right and left rear-view mirror units of the vehicle, mirrors of the right and left rear-view mirror units of the vehicle, and front and/or rear doors of the vehicle.

For the purposes of the present invention, the references “up”, “down”, “front”, “rear”, “right” and “left” will be understood as being relative to an observer seated in the vehicle, more specifically on the seat assigned to the driver of the vehicle.

As illustrated in FIG. 1, the device 1 comprises a support 10 and control means for controlling the movement of the various accessories. These control means are located on the support 10.

The support 10 is an integral support.

For the purposes of the present invention, the term “integral support” is intended to mean a support comprising a single part, formed for example by molding, or a support comprising a number of parts, all the parts of the support being in contact with one another such that the support thus obtained is integral.

In one embodiment, the support is made of plastic.

The device 1 comprises first control means 11 which can be actuated by a user to control the movement of the right and left rear-view mirror units of the vehicle (movement of the rear-view mirror unit relative to the vehicle door on which said rear-view mirror unit is fastened).

More specifically, actuating the first control means 11 makes it possible for the right and left rear-view mirror units to be folded in and out.

The device 1 additionally comprises first selection means 21 which can be actuated by the user.

The first selection means 21 allow the user to select a movement control mode for the rear-view mirror unit from a number of control modes for the rear-view mirror unit.

In one embodiment, actuating the first selection means 21 allows the user to select a control mode for the rear-view mirror unit from:
a first control mode for the rear-view mirror unit whereby the movement of the rear-view mirror unit is controlled by the first control means 11, and
a second control mode for the rear-view mirror unit whereby the movement of the rear-view mirror unit is controlled by other control means for the rear-view mirror unit that are not located on the support 10.

For example, the other means not located on the support 10 are a remote control for locking/unlocking the doors of the vehicle.

In this case, the movement of the rear-view mirror unit is controlled by actuating the remote control, actuation of the remote control to unlock the doors of the vehicle causing the right and left rear-view mirror units to fold out, and actuation of the remote control to lock the doors of the vehicle causing the right and left rear-view mirror units to fold in.

In all cases, when the second control mode for the rear-view mirror unit is selected, the outward folding movement and the inward folding movement of the right and left rear-view mirror units is performed “automatically”, that is to say that it does not result directly from the user's will to control the movement of these rear-view mirror units, but is associated with another functionality of the vehicle that the user wishes to control (such as locking/unlocking of the doors).

Conversely, when the first control mode for the rear-view mirror unit is selected, the movement of the rear-view mirror units of the vehicle results directly from the user's will to control the movement of these rear-view mirror units by actuating the first control means 11. This is referred to as “manual” mode.

When the first control mode for the rear-view mirror unit is selected, the movement of the right and left rear-view mirror units is exclusively controlled by the first control means 11.

Thus, the movement of the rear-view mirror units is no longer associated with the other functionality. For example, locking (or unlocking) the doors of the vehicle by actuating the remote control will not include folding in (or folding out) the folded-out (or folded-in) rear-view mirror units when the first control mode for the rear-view mirror unit is selected.

When the second control mode for the rear-view mirror unit is selected, the movement of the right and left rear-view mirror units is exclusively controlled by the other control means not located on the support 10.

The first selection means allow the user to have greater control over the functionalities of his vehicle; in particular, these first selection means allow the user to choose the control mode for the rear-view mirror unit that is best suited to the situation in which he finds himself by selecting either the automatic mode or the manual mode.

In one embodiment, the first control means 11 and the first selection means 21 are integrated within one and the same assembly 20.

This assembly 20 is, for example, a rocker button with three fixed positions, these positions being associated with a specific control. This makes it possible to simplify the use of these two movement functionalities of the rear-view mirror units.

For example, actuation by the user of the rocker button so as to position it:
in a first fixed position, allows the user to select the manual mode and to fold out the rear-view mirror units,
in a second fixed position, allows the user to select the manual mode and to fold in the rear-view mirror units,
in a third fixed position, allows the user to select the automatic mode.

In another embodiment, the device 1 additionally comprises second control means 12 which can be actuated by the user to control the movement of the front and/or rear windows of the vehicle.

More specifically, actuation of the second control means 12 makes it possible to control the up or down movement of the front and/or rear windows of the vehicle.

In one embodiment, the second control means 12 are three-position rocker buttons having only one position which is fixed, no movement being brought about when these buttons are in their fixed position, and actuation by the user of these buttons in one or other of the other two positions causing the windows of the vehicle to move up or down for as long as the user continues to actuate the second control means (when the user stops pressing on the second control means, the movement of the windows is interrupted).

In another embodiment, the second control means 12 are five-position rocker buttons having only one position which is fixed, no movement being brought about when these buttons are in their fixed position. The additional two positions with respect to the preceding three positions correspond to the possibility of lifting the window right up or right down in response to a single push.

The second control means 12 can comprise two or four rocker buttons, each button being associated with the control of one window of the vehicle.

In another embodiment, the device additionally comprises third control means 13 for controlling the movement of the mirror of the right rear-view mirror unit or of the left rear-view mirror unit.

More specifically, actuation of the third control means 13 makes it possible to pivot the mirror of the rear-view mirror unit about two mutually perpendicular axes passing through the centers of the sides of the mirror.

The third control means 13 comprise, for example, a circular knob with five positions only one of which is fixed, no movement being brought about when this circular knob is in its fixed position, and actuation by the user of the circular knob so as to place it in one of the other four non-fixed positions causing the mirror to pivot about one or other of the two axes.

In another embodiment, the device comprises second selection means 22 which can be actuated by the user to select the mirror that the user wishes to move by actuating the third control means 13.

The second selection means 22 comprise, for example, a rocker button with three fixed positions, two of the three positions being associated with the selection of a mirror, and the third position deactivating the third control means 13, such that when the second selection means 22 are in the third position, actuation of the third control means 13 does not produce a movement of one or other of the two mirrors.

For example, actuation by the user of the rocker button so as to move it:
into the first fixed position, allows the user to select the mirror of the left rear-view mirror unit (thus, actuation of the third control means will cause the mirror of the left rear-view mirror unit to move when the second selection means 22 are in this first position),
into the second fixed position, allows the user to select the mirror of the right rear-view mirror unit (thus, the movement of the third control means 13 causes the mirror of the right rear-view mirror unit to move),
into the third fixed position, or neutral position, allows the user to deactivate the third control means.

In another embodiment, the device comprises fourth control means 14 which can be actuated by the user to control the movement of the front and/or rear side doors of the vehicle.

More specifically, actuating the fourth control means 14 makes it possible to open or close the front and/or rear side doors of the vehicle.

In one embodiment, the device comprises fifth control means 15 for deactivating or activating certain of the aforementioned control means, such as, for example, the second control means 12 for controlling the movement of the windows and/or the fourth means 14 for controlling the movement of the front and/or rear doors of the vehicle.

The fifth control means 15 comprise, for example, a rocker button with two fixed positions; actuation by the user of the rocker button with two fixed positions so as to place it:
in the first fixed position, allows the user to activate the second control means 12 and/or the fourth control means,
in the second fixed position, allows the user to deactivate the second control means 12 and/or the fourth control means 14.

The reader will have understood that, apart from the function of deactivating the second and/or fourth control means, the fifth control means can make it possible to deactivate auxiliary control means which are not located on the support and which allow the movement of the rear electric windows and/or doors of the vehicle to be controlled.

For example, if the rear doors of the vehicle comprise auxiliary control means to allow the passenger situated in the rear of the vehicle to control the movement of the rear electric windows and/or doors, actuation of the fifth control means to deactivate the second control means can also allow deactivation of the auxiliary control means.

The fact that the plurality of control means is situated on the support designed to be fastened on the door of the vehicle makes it possible to provide an ergonomic and easy-to-use control system, all the control means being situated at the same user-accessible location.

The fact that the plurality of control means is situated on the support designed to be fastened on the door of the vehicle also makes it possible to limit the length of cable used in the vehicle for installing such control means.

The reader will have understood that many modifications can be made without substantively departing from the teachings and advantages described herein. For example, the number of buttons of the various control and selection means can vary depending on the number of electric accessories to be controlled and on the desired ergonomics for the device of the present invention.

Therefore, all the modifications of this type are intended to be incorporated within the scope of the device as it is defined in the appended claims.

### REFERENCES

1 Device
10 Support
20 Assembly
11 First control means
12 Second control means
13 Third control means
14 Fourth control means
15 Fifth control means
21 First selection means
22 Second selection means

1-10. (canceled)

11. A control device comprising:
a support;
control means on the support that can be actuated by a user to control movement of a rear-view mirror unit; and
selection means on the support that can be actuated by the user to select:
a first control mode whereby the movement of the rear-view mirror unit is controlled by the control means, or
a second control mode whereby the movement of the rear-view mirror unit is controlled by other means not located on the support.

12. The device as claimed in claim 11, further comprising second control means that can be actuated by the user to control movement of a window of the vehicle, the second control means being located on the support.

13. The device as claimed in claim 12, further comprising third control means that can be actuated by the user to control movement of a mirror of the rear-view mirror unit, the third control means being located on the support.

14. The device as claimed in claim 11, wherein the support is formed in a single piece.

15. The device as claimed in claim 11, wherein the support is configured to be fastened on a door of the vehicle.

16. The device as claimed in claim 11, wherein the first control means and the selection means are integrated within one and a same assembly.

17. The device as claimed in claim 16, wherein the assembly comprises a rocker button with three positions.

18. The device as claimed in claim 12, wherein the second control means comprises at least one button that can be actuated to control the movement of the window of the vehicle.

19. The device as claimed in claim 13, further comprising fourth control means that can be actuated by the user to control movement of an electric door of the vehicle, the fourth means being located on the support.

20. The device as claimed in claim 19, further comprising fifth control means that can be actuated by the user to deactivate the second control means and/or the fourth control means.
